(19) United States
(12) Patent Application Publication
(10) Pub. No.: US 2007/0223439 A1
(43) Pub. Date: Sep. 27, 2007

(54) Wireless communication method, wireless communication apparatus and wireless communication program

(75) Inventor: Jun Kosai, Tokyo (JP)

Correspondence Address: OLIFF & BERRIDGE, PLC, P.O. BOX 19928, ALEXANDRIA, VA, 22320, US

(73) Assignee: TOYOTA INFOTECHNOLOGY CENTER CO., LTD., TOKYO (JP)

(21) Appl. No.: 11/717,746

(22) Filed: Mar. 14, 2007

(30) Foreign Application Priority Data
Mar. 27, 2006 (JP) 2006-085563

(51) Int. Cl. H04Q 7/24

(52) U.S. Cl. 370/338

(57) ABSTRACT

A two-hop distant node is recognized by exchanging a Hello message, and an RTS message is transmitted through a doubled transmission distance prior to transmission of a data packet. Each node manages a channel available to a self node and an adjacent node in a channel status table based on the RTS message. A node which tries to transmit the data packet refers to the channel status table, so as to be capable of easily selecting a channel available to the self node and a node of a communication destination. Transmission wireless field strength is enhanced or a modulating system strongly resistant to noises is used so that the RTS message is transmitted at a distance which is not less than twice as long as that of the Hello message and the data packet.

### BACKGROUND OF THE INVENTION

1. Field of the Invention

The present invention relates to wireless communication which is conducted by using a plurality of channels.

2. Description of the Related Art

Conventionally, wireless packet communication such as wireless LAN uses a CSMA/CA (Carrier Sense Multiple Access with Collision Avoidance) system. In the CSMA/CA system, in order to conduct communication with a common wireless channel being shared, a node which tries to transmit a packet first checks that other wireless terminals do not use the wireless channel, and then transmits a RTS (Request To Send) message to a receiving node. The node which receives the RTS message returns a CTS (Clear To Send) message to the transmitting node. The transmitting node receives the CTS message and then starts actual transmission of data packet. The RTS message and the CTS message include the time for which the channel is occupied, namely, the time until the transmission of the data packet is completed.

A node adjacent to the transmitting node which receives the RTS message and a node adjacent to the receiving node which receives the CTS message do not carry out transmission and reception for a period for which the transmitting and receiving nodes occupy the channel. Thus, packet collisions are avoided in communication using shared channel.

The above explanation refers to the wireless communication method where one channel is shared, but the following document refers to a wireless communication method where a plurality of channels are shared. The document is Shih-Lin Wu et al., “A New Multi-Channel MAC Protocol with On-Demand Channel Assignment for Multi-Hop Mobile Ad Hoc Networks”, Proceedings of the Fifth International Symposium on Parallel Architectures, Algorithms, and Networks (ISPAN'00), IEEE, 2000.

In this wireless communication method, one of the plural channels is used as a control channel, and the other channels are used for data packet. The nodes use the control channel in order to determine a channel to be used for transmission of data packet.

The specific procedure of the wireless communication method is explained with reference to FIGS. 12A and 12B. In a network topology condition of FIG. 12B, the process of transmitting a data packet from a node mS to a node mD is explained with reference to FIG. 12A. Nodes m1 and m2 are positioned within a communication range of the node mS, and nodes m3 and m4 are positioned within a communication range of the node mD. The node mS which tries to start the transmission transmits an RTS message which stores a channel available to the self node therein. The adjacent nodes m1 and m2 which receive the RTS message are brought into a transmission forbidden state (NAV: Network Allocation Vector) for all the channels for a predetermined period. The node mD which receives the RTS message transmits a CTS message which stores a channel available to the self node (determined as a channel i) among the channels available to the node mS stored in the RTS message. The adjacent nodes m3 and m4 which receive the CTS message prohibit the communication through the channel i until the communication between the nodes mS and mD is completed. The node mS which receives the CTS message transmits an RES (REServation) message in order to post the transmission of the data packet using the channel i to the surround. The adjacent nodes m1 and m2 which receive the RES message prohibit the communication through the channel i until the communication between the nodes mS and mD through the channel i is completed.

According to such a method, a channel to be used is selected from the plural channels, so that the packet collisions are avoided. When the plural channels can be used, the throughput of the entire system can be improved.

However, in the case where the communication is conducted by using the plural channels according to the above conventional technique, the following problems arise.

Firstly, prior to the transmission of data packets, it is necessary to conduct communication of three control packets including RTS, CTS and RES through the control channel. When communication traffic increases, the control packets could use up the control channel. Under such a circumstance, even if a data channel is still available, the control channel becomes bottleneck, thereby deteriorating the throughput. In the case where a broadcast packet is also transmitted through the control channel, the possibility of generating congestion in the control channel is heightened. It is, therefore, desired to reduce an amount of packets to be transmitted through the control channel.

Secondly, the RTS message could be transmitted to a node without an available channel. For example, under a circumstance shown in FIG. 13, since the node m1 is in the communication-enabled range of the node mS, the use of the channels is prohibited (assume that the use of all the channels is prohibited). However, since the node m5 does not recognize that the node m1 has no available channel, when the node m5 tries to communicate with the node m1, it transmits the RTS message to the node m1. At this time, the RTS message from the node m5 is received also by a node m6, and when the node m6 receives the RTS message, it comes into the NAV state for a predetermined period. That is to say, the node m6 is brought into NAV state by the RTS message, which is not necessary to be transmitted if the node m5 recognizes that it cannot communicate with the node m1. Therefore, if the transmission of such a useless RTS message (under a circumstance that the communication cannot be started) can be repressed, the improvement of communication efficiency can be assumed.

### SUMMARY OF THE INVENTION

The object of the present invention is to realize efficient communication in a wireless communication system using a plurality of channels.

In order to attain the above object, in the present invention, wireless communication is conducted in the wireless communication system using a plurality of channels by the following units and process. That is to say, each node in the wireless communication system stores a channel available to a self node and a node adjacent to the self node (the node to which the self node can transmit a data packet directly without another node relaying) in a channel status table, and selects a channel to be used for transmission of data packets based on this table. When such a channel status table is used, the transmitting node can determine a channel that the receiving node can is able to use without exchanging the control packet. Therefore, the number of control packets to be transmitted before the transmission of the data packets can be reduced, so that efficient communication can be realized.

Hereafter, the node adjacent to the self node (the node with which direct communication can be conducted without relay) is referred to as a primary adjacent node (or simply, an adjacent node). A node which is not adjacent to the self node but is adjacent to the primary adjacent node of the self node is referred to as a secondary adjacent node. Since the self node can communicate directly with the primary adjacent node, the primary adjacent node is also referred to as a node of a one-hop distance (also, one-hop node or one-hop distant node) Since the self node can communicate with the secondary adjacent node via a relay of the primary adjacent node, the secondary adjacent node is also referred to as a node of a two-hop distance (also, two-hop node or two-hop distant node). In the present invention, as described later, a communication range of data packets is made to be different from a communication range of a channel reservation notification, but the words “adjacent” and “adjacent node” are on the basis of the communication range of data packets. Therefore, the words “primary adjacent node” and “secondary adjacent node” are also on the basis of the communication range of data packets. That is to say, if a data packet is not directly reaches a node, this node is not the primary adjacent node but the secondary adjacent node, even though the channel reservation notification reaches directly to that node.

The specific wireless communication method according to the present invention is explained below. In the wireless communication system, a node which tries to transmit a data packet, transmits the channel reservation notification for notifying a channel to be used for transmission, a transmitting node (self node) and a receiving node to surrounding nodes. The channel reservation notification is transmitted from the self node to both of the primary adjacent nodes and the secondary adjacent nodes.

A node which receives the channel reservation notification updates the channel status table which stores a channel available to the self node and the primary adjacent node therein based on the channel reservation notification. More specifically, a node adjacent to any one of the transmitting node and the receiving node (the transmitting node and the receiving node are included in the received reservation notification) updates the channel status table such that the channel specified by the channel reservation notification cannot be used (not available). This is because an adjacent node of the transmitting/receiving node cannot use the channel due to interference by a radio wave. It is noted that “the node adjacent to any one of the transmitting node and the receiving node” includes both the self node (the node that receives the notification) and the primary adjacent node of the self node.

In the process for updating the channel status table, it is preferable that a process for determining a node adjacent to the transmitting/receiving node included in the channel reservation notification is executed based on the topology information table that stores the primary adjacent node and the secondary adjacent node of the self node. It is, therefore, preferable that each node of the wireless communication system stores the primary adjacent node and the secondary adjacent node of the self node as a topology information table. The topology information table can be generated in such a manner that each node in the wireless communication system exchanges topology information notification for notifying the primary adjacent node of the self node. It is more preferable that the topology information notification is exchanged periodically and the topology information table is updated periodically.

As described above, by using the channel reservation notification which can be transmitted directly to both of the primary and the secondary adjacent node, each node in the wireless communication system can get information about the channel available to the self node and the primary adjacent node. In the conventional art, when the the communication is started from the node of the two-hop distance (secondary adjacent node) to the primary adjacent node, the self node receives the CTS message from the primary adjacent node (receiving node) so as to determine that a channel cannot be used. On the contrary, in the present invention, since the self node is able to receive the channel reservation notification transmitted from the node of the two-hop distance, the self node can determine that the channel to be used for transmission cannot be used without using the CTS message. Further, when the nodes of two-hop distance communicate with each other, since the self node is able to receive the channel reservation notification, the self node can determines that the adjacent node is interfered by the communication between the nodes of two-hop distance. Therefore the self node is able to recognize that it cannot communicate with the adjacent node using that channel.

When the channel available to the self node and the primary adjacent node is stored in the channel status table, the node which tries to transmit a data packet can easily select a channel to be used for transmission of the data packet. That is to say, the channel can be selected only by referring to the channel status table without exchanging a control packet with the receiving node.

It is preferable that the channel reservation notification is transmitted so as to propagate a distance at least twice as long as a transmission distance of the data packet. With such a constitution, the channel reservation notification can be transmitted to all the secondary adjacent nodes (the nodes of two-hop distance), and each node can suitably get information about the channel status (availability). In order to lengthen the transmission distance of the channel reservation notification, for example, the transmission wireless field strength of the channel reservation notification may be enhanced. Further, such a modulating system that the notification is receivable with lower S/N ratio can be employed for transmission of the channel reservation notification.

It is preferable that a plurality of channels to be used in the wireless communication system including a broadcast channel for transmitting a broadcast packet, a control channel for transmitting a control packet, and a plurality of data channels for transmitting data packets. It is preferable that the topology information notification is transmitted through the broadcast channel, the channel reservation notification is transmitted through the control channel and the data packet is transmitted through any one of the data channels. It is preferable that each node has first and second radio devices and that the first radio device is used specially for the broadcast channel, and the second radio device switches the channel between the control channel and the data channel. According to the above method, the second radio device can conduct appropriate communication where packet collisions are avoided while switching the channel between the control channel and the data channel. Therefore, the first radio device can be used specially for the broadcast.

The present invention may also be considered as a wireless communication apparatus having a function for executing at least a part of the above process. Further, the present invention may also be considered as a program for realizing the above process. The above units and the processes may be combined as many as possible so as to configure the present invention.

For example, a wireless communication apparatus from one aspect of the present invention includes: a channel status table in which a channel available to a self node and a primary adjacent node is stored, the primary adjacent node being a node adjacent to the self node; and a channel selecting unit that selects the channel available to the self node and the primary adjacent node as a channel to be used for transmission of a data packet to the primary adjacent node based on the channel condition table. It is preferable that this wireless communication apparatus further includes: a channel reservation notification transmission unit that transmits channel reservation notification to the primary adjacent node and a second adjacent node, the channel reservation notification notifying a channel to be used for transmission, a transmitting node and a receiving node, the secondary adjacent node being a node non-adjacent to the self node but adjacent to the primary adjacent node; and a channel status table updating unit that updates the channel status table based on the received channel reservation notification.

A wireless communication program from one aspect of the present invention allows a wireless communication apparatus using a plurality channels to be conducted, the program allowing a wireless communication apparatus having a status table for storing a channel available to a self node and a primary adjacent node as a node adjacent to the self node therein to execute the step of selecting the channel available to the self node and the primary adjacent node as a channel to be used for transmission of a data packet to the primary adjacent node based on the channel status table. It is preferable that this wireless communication program allows the wireless communication apparatus to execute: the step of transmitting channel reservation notification to the primary adjacent node and a second adjacent node, the channel reservation notification notifying a channel to be used for the transmission, a transmitting node and a receiving node, the second adjacent node being a node non-adjacent to the self node but adjacent to the primary adjacent node; and the step of updating the channel status table based on the received channel reservation notification.

According to the present invention, in the wireless communication system using a plurality of channels, efficient communication can be realized.

### BRIEF DESCRIPTION OF THE DRAWINGS

FIG. 1 is a functional block diagram illustrating a wireless communication apparatus according to an embodiment;

FIG. 2 illustrates an example of a wireless communication network topology according to the embodiment;

FIG. 3 illustrates an example of a topology information table;

FIG. 4 illustrates an example of a channel status table;

FIG. 5 is a flowchart illustrating a flow of a channel selecting process;

FIG. 6 is a flowchart illustrating a flow of a process for acquiring an interference channel of a transmitting node in the channel selecting process;

FIG. 7A is a sequence diagram of packets transmitted/received at the time of transmitting data packets, and FIG. 7B illustrates a network topology at that time;

FIG. 8 illustrates a format of an RTS message;

FIG. 9 illustrates a format of a Hello message;

FIG. 10 is a flowchart illustrating a flow of a topology information table updating process to be executed at the time of receiving the Hello message;

FIG. 11 is a flowchart illustrating a flow of a channel status table updating process to be executed at the time of receiving the RTS message;

FIG. 12A is a sequence diagram of packets to be transmitted/received at the time of transmitting the data packet in a conventional art, FIG. 12B illustrates a network topology at that time; and

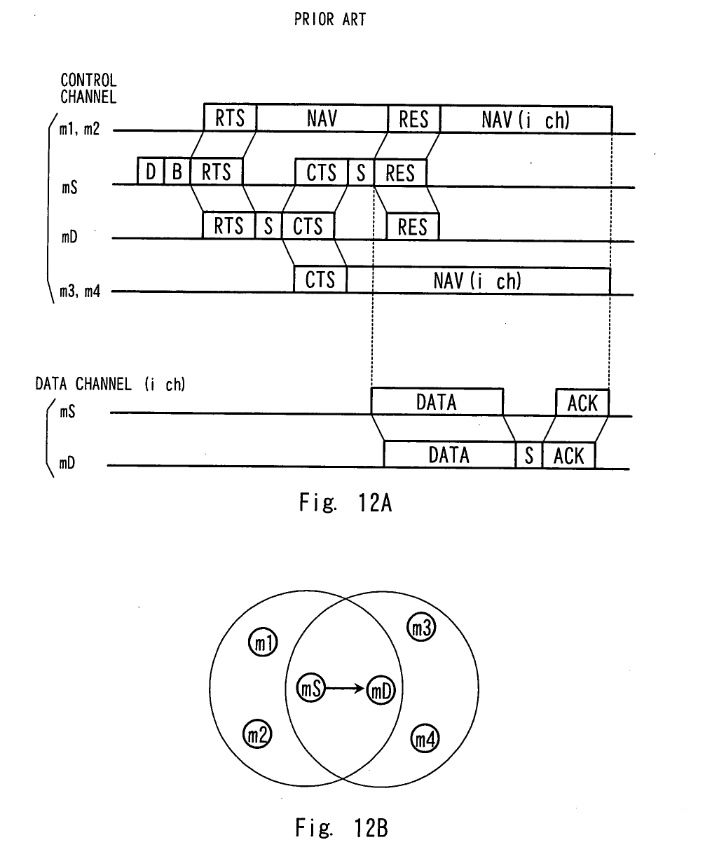

FIG. 13 is a diagram explaining a condition that surrounding nodes are brought into an NAV state by a useless RTS message in a conventional art.

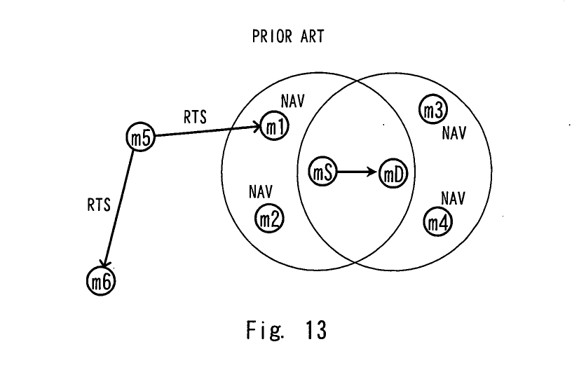

### DESCRIPTION OF THE PREFERRED EMBODIMENTS

A preferred embodiment of the present invention is explained in detail below with reference to the drawings in an exemplified manner.

A wireless communication system according to the embodiment conducts wireless communication using a plurality of channels. In the embodiment, each node in the wireless communication network manages channels (data channel) available to a self node and adjacent nodes in a channel status table. As a result, a channel which is used for transmitting data packets can be easily selected, and when starting transmission of data packets the number of control packets to be transmitted on a control channel can be reduced.

In the embodiment, one broadcast channel, one control channel, and four data channels are used. In the embodiment, multi-channel connection is realized by an FDMA (Frequency Division Multiple Access) system. The multi-channel connection may be realized by other wireless communication systems such as CDMA (Code Division Multiple Access) and OFDMA (Orthogonal Frequency Division Multiple Access).

A method of selecting a channel based on a channel status table is explained in detail below. A method of generating such a channel status table is also explained in detail.

### <Functional Configuration>

A wireless communication apparatus 1 according to the embodiment is explained. The wireless communication apparatus 1 may include a CPU (Central Processing Unit), a main storage unit (RAM), an auxiliary storage unit (ROM), a communication interface and the like as a hardware configuration. These components of the wireless communication apparatus 1 are connected via bus. The wireless communication apparatus 1 is provided with two communication interfaces (radio devices), one of them uses only the broadcast channel and the other uses the control channel and the four data channels in a switching manner.

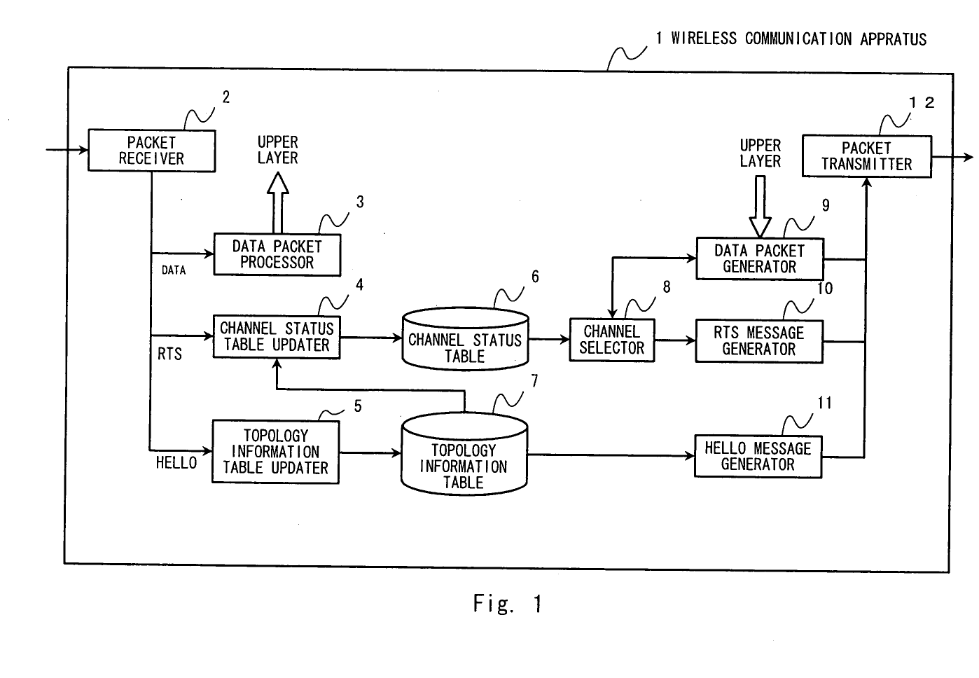

FIG. 1 is a diagram illustrating a functional block example of the wireless communication apparatus 1. When various programs (OS, application, etc.) stored in the auxiliary storage unit are loaded into the main storage unit and are executed by the CPU, the wireless communication apparatus 1 according to the embodiment functions as a packet receiver 2, a data packet processor 3, a channel status table updater 4, a topology information table updater 5, a channel status table 6, a topology information table 7, a channel selector 8, a data packet generator 9, an RTS message generator 10, a Hello message generator 11 and a packet transmitter 12. All or some functions of the wireless communication apparatus 1 according to the embodiment may be constituted by special chips.

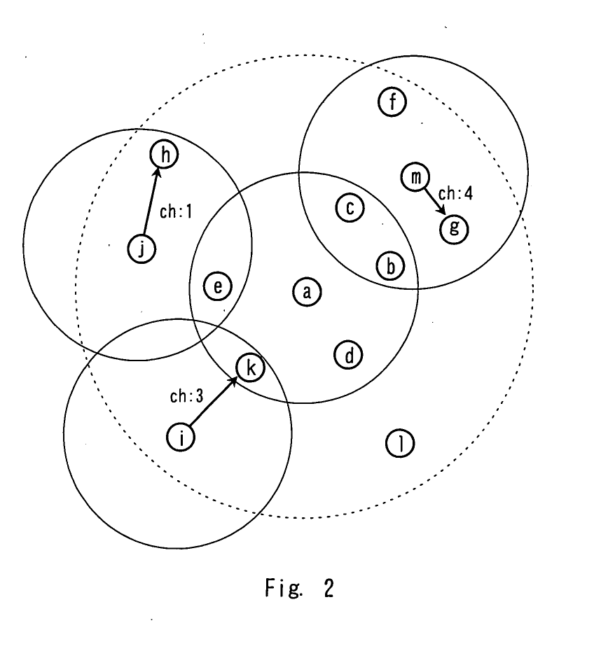

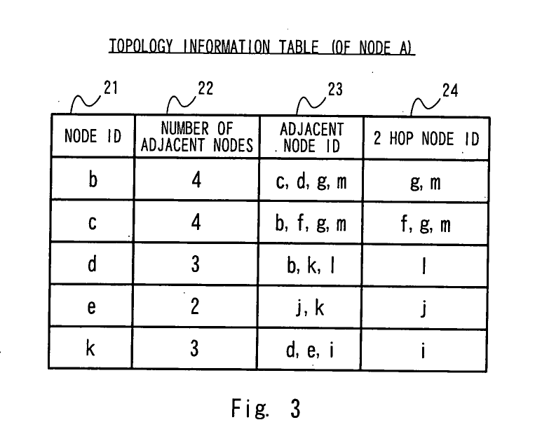

The topology information table 7 is a table into which nodes adjacent to a self node and nodes of two-hop distance are stored. FIG. 3 is a diagram illustrating an example of the topology information table, and is the topology informaton table owned by a node “a” of a network topology shown in FIG. 2. A node ID 21, the number of adjacent nodes 22, an adjacent node ID 23, two-hop node 24 are stored in the topology information table. IDs of nodes adjacent to the node having this table (node “a”) are stored in the node ID 21. The number of nodes adjacent to respective nodes is stored in the number of adjacent nodes 22. The node “a” (self node) is not included in the number of adjacent nodes. That is to say, for example, nodes adjacent to a node “b” are five nodes including nodes “a”, “c”, “d”, “g” and “m”, but “4” excluding the node “a” is stored in the number of adjacent nodes 22. IDs of nodes adjacent to respective nodes are stored in the adjacent node ID 23. The node “a” (self node) is omitted here, too. A node of two hop distance from the node “a” among the nodes adjacent to respective nodes is stored in the two-hop node 24. More specifically, a node, which is included in the nodes adjacent to the respective nodes and is not included in the nodes adjacent to the node “a”, corresponds to the node of two-hop distance.

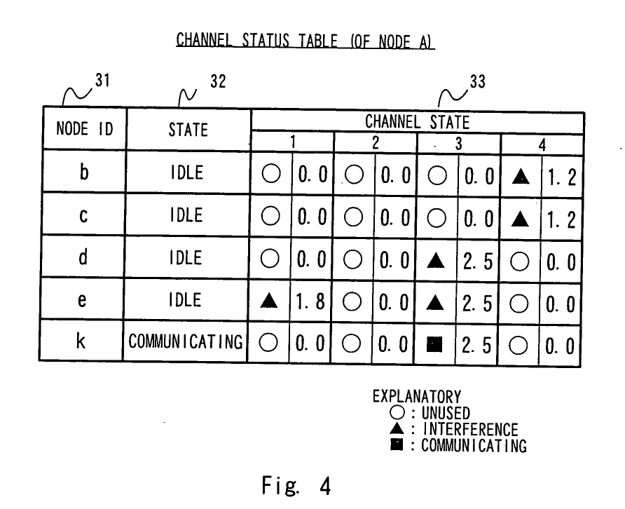

The channel status table 6 is a table in which channels available to a self node and adjacent nodes are stored. FIG. 4 is a diagram illustrating an example of the channel status table, and is the channel status table owned by the node “a” in the network topology and a communicating situation shown in FIG. 2. In FIG. 2, communicating nodes are connected by a line with an arrow, and a data channel used for the the communication is shown next to it. A node ID 31, a state 32 and a channel state 33 are stored in the channel status table 6. “Idle” or “communicating” is stored as the communication state of each node in the state 32. The channel state 33 shows a use condition of a channel of each node. In FIG. 4, white circle represents that the channel is available, a black triangle represents that a channel is interfered because surrounding nodes are conducting communication, and a black square represents that the node is being used for the communication. In the case of interfering and using, a transmission period (duration) which is the time until the channel becomes available is stored simultaneously with the use condition. In the channel status table 6, since the state 32 can be obtained from the channel state 33 (with respect to the channel state, a node having a communicating channel is communicating, and the other nodes are in the idle state), the state 32 can be omitted.

The node which has the channel status table 6 can get information about a channel available to the adjacent node based on this table. With respect to a channel available to the self node, the node can get information about available channel other than the channel used for the communication by the adjacent node (in FIG. 4, channel 3 is used by a node “k”).

In this embodiment, the channel status table 6 and the topology information table 7 are structured as different tables, but may be structured as one table by using node ID as a key.

The packet receiver 2 receives a packet from other wireless communication apparatus. The packet receiver 2 transmits the received packet to one of the data packet processor 3, the channel status table updater 4, or the topology information table updater 5 in accordance with the type of the packet. The data packet transmitted to the data packet processor 3 is transmitted to a higher layer.

The RTS message (channel reservation notification) received by the receiver 2 is sent to the channel status table updater 4. The channel status table updater 4 updates the channel status table 6 based on the RTS message.

The Hello message (topology information notification) received by the receiver 2 is sent to the topology information table updater 5. The topology information table updater 5 updates the topology information table 7 based on the Hello message.

The data packet generator 9 generates data packets to be transmitted. Prior to the transmission of data packets, the channel selector 8 selects a channel to be used based on the channel status table 6. The RTS message generator 10 generates the RTS message for notifying surrounding nodes of a channel to be used for the transmission of data packets, a transmitting node (self node) and a receiving node.

The Hello message generator 11 generates the Hello message for posting the node adjacent to a self node based on the topology information table 7. The Hello message generator 11 generates the Hello message periodically.

The packet transmitter 12 transmits the data packets generated by the data packet generator 9, the RTS message generated by the RTS message generator 10, and the Hello message generated by the Hello message generator 11. The packet transmitter 12 transmits a data packet using any one of the four data channels, the RTS message using the control channel, and the Hello message using the broadcast channel. When transmitting the RTS message, the packet transmitter 12 increases transmission radio field strength or uses a modulating system which makes the message receivable even if its S/N ratio is low, so as to make a transmission distance of the RTS message at least twice as long as that of the data packets and the Hello message. When the RTS message is allowed to directly reach the two-hop distant nodes in such a manner, the channel reservation can be posted to the two-hop distant nodes, thereby simplifying the updating of the channel status table.

### <Process Flow>

### [Channel Selecting Process]

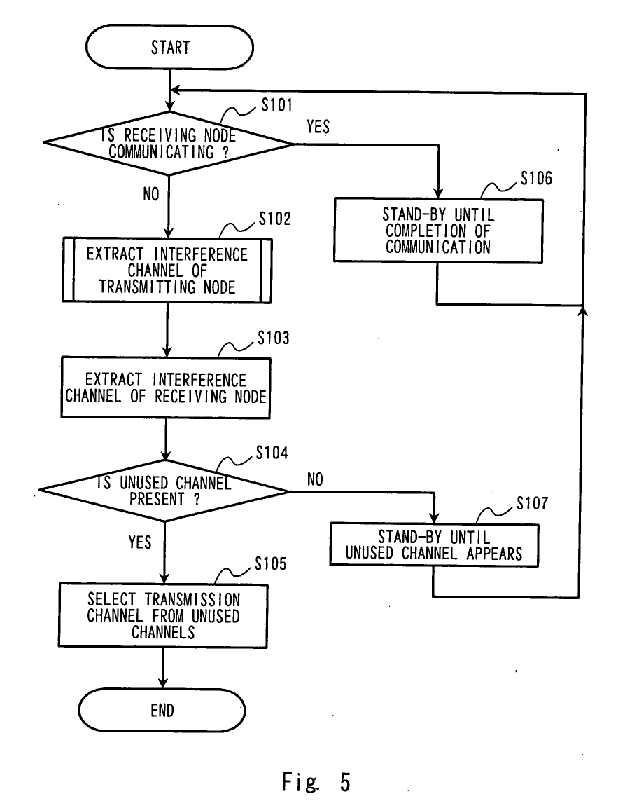

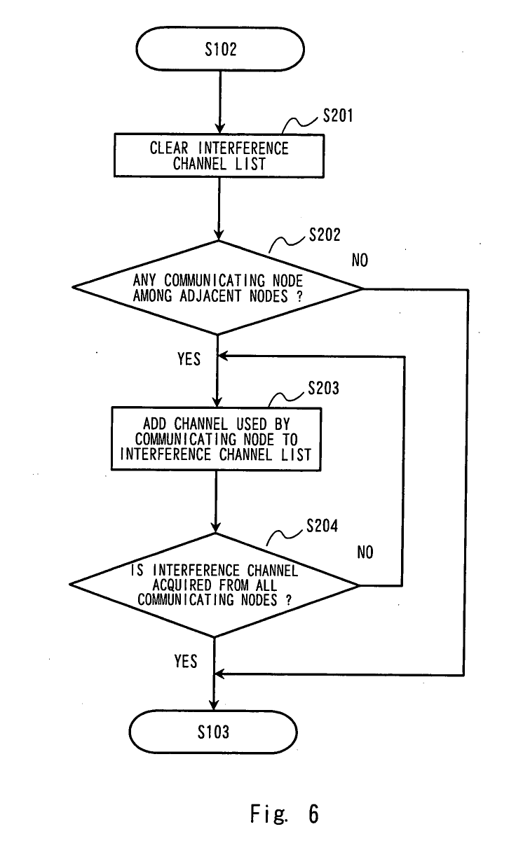

A process for selecting a channel to be used for transmission of data packets is explained below with reference to the channel status table 6. Here, the channel selecting process is explained on the condition that the channel status table 6 is already generated. A method of generating the channel status table 6 is explained later. FIGS. 5 and 6 are flowcharts illustrating a flow of the channel selecting process executed by the channel selector 8.

FIG. 5 is the flowchart illustrating the entire flow of the channel selecting process. The channel selector 8 refers to the channel status table 6, and determines whether a receiving node is communicating (S101). When the receiving node is communicating (Yes at S101), the process stands by until the receiving node ends the communication (S106). When the receiving node is not communicating (No at S101), the channel selector 8 acquires a channel interfered by other nodes based on the channel status table 6 (S102).

Details of a process for extracting an interference channel around the self node are explained with reference to the flowchart of FIG. 6. The channel selector 8 clears an interference channel list in which interference channels are stored (S201). The channel selector 8 refers to the channel status table 6, and determines whether there is a communicating node among the adjacent nodes (S202). If there is communicating node among the adjacent nodes (Yes at S202), the channel selector 8 adds the channel which is used for the communication by that node to the interference channel list (S203). The channel selector 8 determines whether interference channels interfered by all the nodes in communication are acquired (S204). When there is a communicating node whose transmitting channel is not acquired yet (No at S204), the sequence returns to S203 so that the channel selector 8 adds the interference channel to the interference channel list. When all the interference channels interfered by all the communicating nodes are acquired (Yes at S204), the process is ended, and the sequence goes to S103. When the adjacent nodes do not include any communicating node (No at S202), the process is ended with the interference channel list containing nothing, and the sequence goes to S103.

The explanation returns to the flowchart of FIG. 5. After acquiring the interference channel of the self node as described above, the channel selector 8 refers to the channel status table 6, and acquires a channel that the receiving node is interfered with (S103). The channel selector 8 acquires the channel that the receiving node is interfered with from the channel status table 6 so as to add it to the interference channel list.

The channel selector 8 determines whether an unused (available) channel is present based on the interference channel list (S104). When the unused channel is not present (No at S104), the channel selector 8 stands by until an unused channel appears (S107), and then the process after S101 is again repeated. When unused channels are present (Yes at S104), the channel selector 8 selects any channel from the unused channels as a transmission channel (S105).

In a channel status shown by the channel status table of FIG. 4 (in the case of FIG. 2), the channel selecting process in the case where the node “a” executes the transmission is explained. The channel with which node “a” is interfered is only the channel 3, which is used by the node “k” in communication. When the receiving node is the node “b”, the node “b” is interfered with a channel 4, and thus the node “a” can communicate with the node “b” using the channel 1 or 2. When the receiving node is a node “e”, the node “e” is interfered with the channels 1 and 3, and thus the node “a” can communicate with the node “e” using the channel 2 or 4.

When the channel status table 6 is structured in such a manner, the channel selector 8 can easily select the channel available to both of the transmitting node (self node) and the receiving node.

### [Data Packet Transmitting Process]

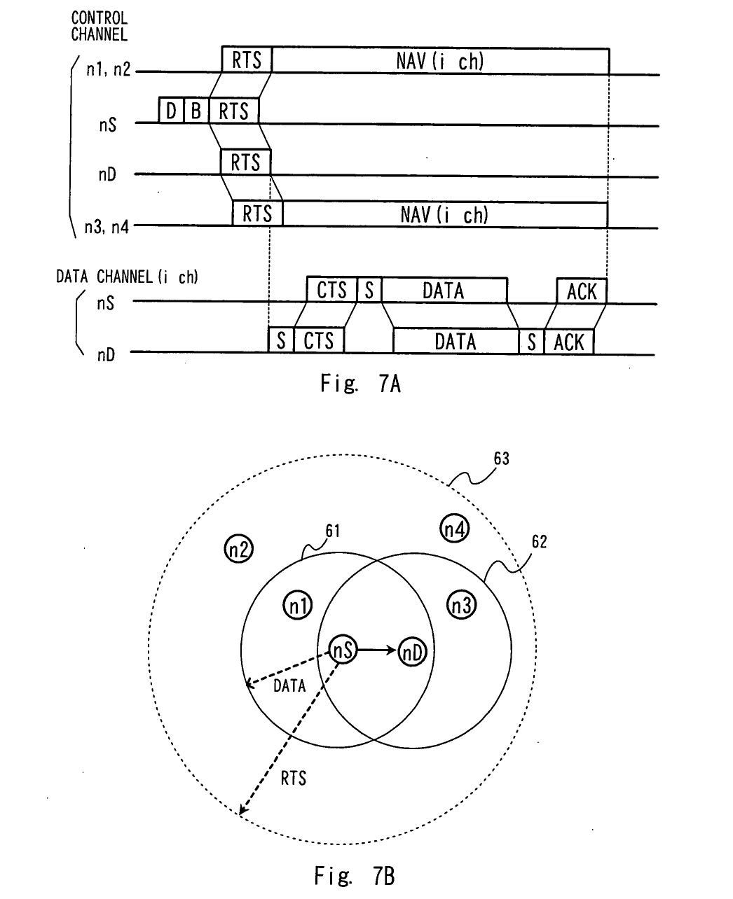

The process for transmitting data packets is explained below with reference to FIGS. 7A and 7B. A node “nS” stands by for DIFS and BACK OFF, checks that the control channel is not used, and then transmits the RTS message through the control channel. After the node “nS” transmits the RTS message through the control channel, it tunes in the radio device to a selected channel.

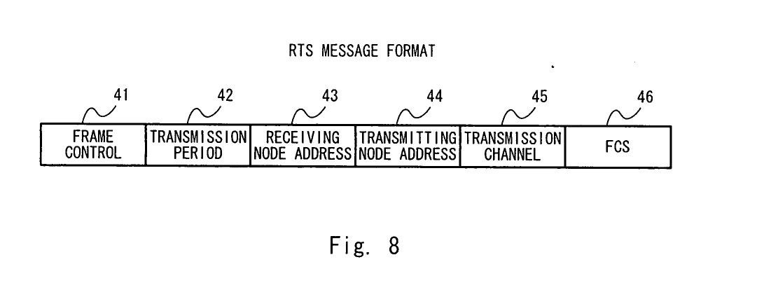

FIG. 8 illustrates a format of the RTS message. A value showing that this message is the RTS message is stored in frame control 41. The time until the communication between the nodes “nS” and “nD” is completed is stored in transmission period 42. An MAC address of the receiving node is stored in receiving node address 43, and an MAC address of the transmitting node is stored in transmitting node address 44. A channel which is used for the communication between the nodes “nS” and “nD” is stored in transmission channel 45. A value for detecting a communication error is stored in FCS 46.

The RTS message transmitted from the node “nS” is received by the node “nD” and the nodes “n1” to “n4”. The nodes “n1” to “n4”, which receive the RTS message showing that the self node is not specified as the receiving node, recognize that the transmission channel 45 stored in the RTS message is not available for the transmission period 42. More specifically, the nodes “n1” and “n3” recognize that they cannot use the specified channel. The node “n2” recognize that the node “n1” can not use the specified channel, and the node “n4” recognize that the node “n3” can not use the specified channel. As a result, the communication between the nodes “nS” and “nD” can be prevented from being interfered by the other nodes.

The node “nD”, which receives the RTS message showing that the self node is specified as the receiving node, transmits the CTS message for acknowledging the reception to the node “nS”. After receiving the RTS message, the node “nD” stands by for SIFS time, and transmits the CTS message through the transmission channel 45 stored in the RTS message. After receiving the CTS message, the node “nS” transmits a data packet.

Because the RTS message is transmitted so as to propagate distance twice as long as that of the other communication, a channel reservation for both adjacent nodes and two-hop nodes is done only by transmitting the RTS message once. Therefore, the control packet to be used prior to the transmission of a data packet can be only one RTS message. Since the packets transmitted through the control channel can be reduced, even if the communication traffic increases, a deterioration of throughput is repressed.

When the nodes “nS” and “nD” complete the communication and try to transmit data to the other nodes, they preferably stand by for a predetermined period. Since the nodes “nS” and “nD” switch a channel used by the radio device from the control channel into the data channel, they cannot acquire the RTS message transmitted from other nodes. Therefore, channel status may not be correctly acquired. After the communication is completed, therefore, it is preferable that the nodes “nS” and “nD” listen the control channel for the time expressed by (CTS length+ACK length+SIFS length×3+maximum frame length)/(communication speed) and then start new communication. The nodes “nS” and “nD” stand by for this period, thereby avoiding interference of the communication started after the starting of the communication between the nodes “nS” and “nD”. When the communication between the nodes “nS” and “nD” is conducted again by using the same channel, the nodes “nS” and “nD” can transmit the RTS message without standing by for this time period, and start the communication again. As a result, the throughput can be improved.

### [Topology Information Table Generating Process]

The process for generating the topology information table 7 is explained below. The topology information table 7 is generated in such a manner that the respective nodes post adjacent nodes of itself to one another, by means of the Hello message. The topology information table 7 is referred to when the channel status table 6 is generated.

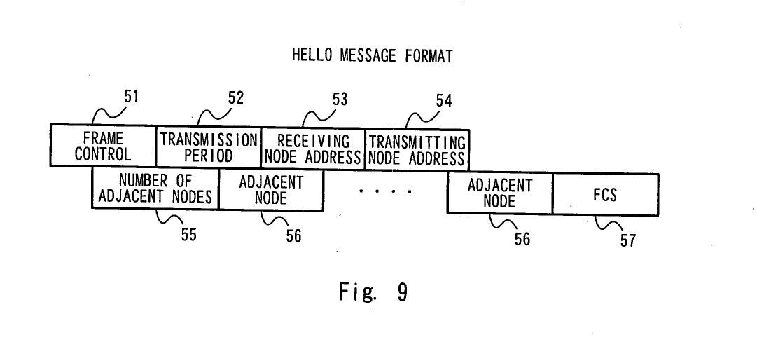

The Hello message generator 11 of each node generates the Hello message periodically, and the packet transmitter 12 transmits the generated Hello message. FIG. 9 illustrates a format of the Hello message. A value representing that this message is the Hello message is stored in frame control 51. The transmission period of this message is stored in transmission period 52. An MAC address of the receiving node is stored in receiving node address 53, and an MAC address of the transmitting node (self node) is stored in transmitting node address 54. The number of nodes adjacent to the self node (nodes which can conduct communication by one hop) is stored in the number of adjacent nodes 55. IDs of the adjacent nodes are stored in adjacent node 56. A value for detecting a communication error is stored in FCS 57.

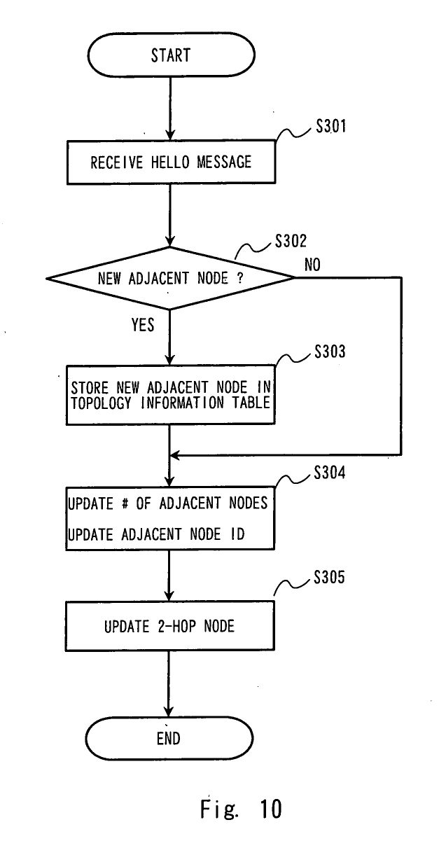

The packet transmitter 12 transmits the generated Hello message through the broadcast channel. FIG. 10 is a flowchart illustrating a flow of the process executed by the node which receives the Hello message.

The node which receives the Hello message sends the Hello message to the topology information table updater 5 (S301). The topology information table updater 5 determines whether the node which transmits the Hello message is a new adjacent node, namely, this node does not appear in the topology information table 7 as an adjacent node of the self node (S302). When the transmission node is a new adjacent node (Yes at S302) the topology information table updater 5 stores this node as the adjacent node in the topology information table 7 (S303). The topology information table updater 5 updates the topology information table 7 using the number of adjacent nodes 55 and the adjacent node ID 56 stored in the Hello message (S304). The topology information table updater 5 updates also two-hop node (S305). Specifically, the topology information table 7 is updated in such a manner that the node that is not stored as an adjacent node in the topology information 7 among the adjacent nodes of the transmitting node, is stored as the two-hop node of the self node. When the node which transmits the Hello message is stored as the two-hop distant node in the topology information table 7, this transmitting node is changed into the adjacent node, and thus this is deleted from node as the two-hop node.

When the Hello message is exchanged in such a manner, each node in the network can get information about the adjacent nodes and the two-hop node of the self nodes.

### [Channel status Table Generating Process]

Lastly, the process for generating the channel status table 6 is explained. The channel status table 6 is generated based on the RTS message which is transmitted prior to the transmission of the data packets and the topology information table 7.

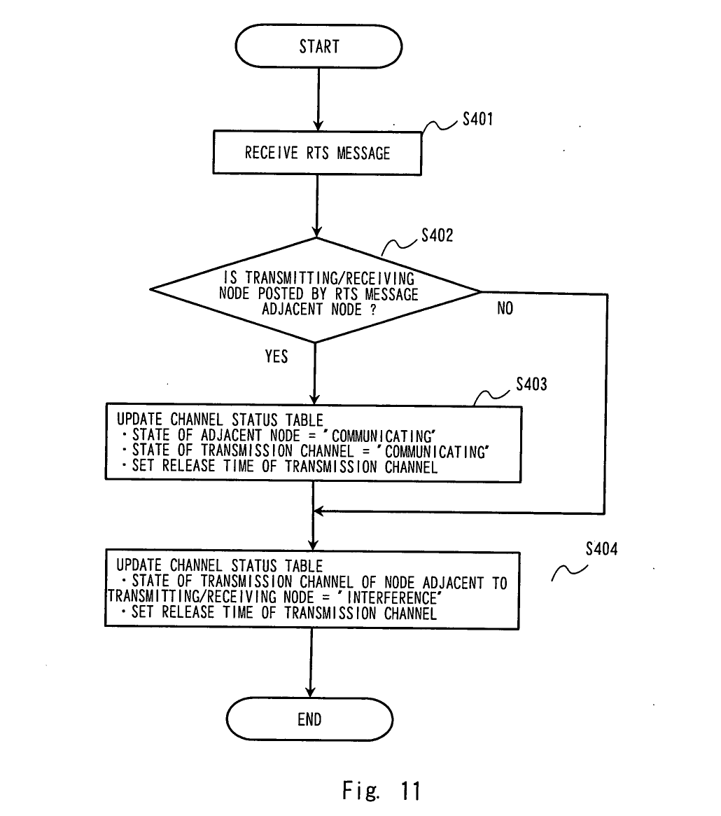

FIG. 11 is a flowchart illustrating a flow of the channel status table generating (updating) process executed by the node which receives the RTS message.

The node which receives the RTS message sends the RTS message to the channel status table updater 4 (S401). The channel status table updater 4 determines whether the transmitting node or the receiving node stored in the RTS message is the adjacent node of the self node. The transmitting node can be acquired from the transmitting node address 44 (FIG. 8) of the RTS message, and the receiving node can be acquired from the receiving node address 43 of the RTS message. The determination of whether the transmitting/receiving node is the adjacent node or not can be made by referring to the topology information table 7.

When the transmitting node or the receiving node stored in the RTS message is the adjacent node of the self node (Yes at S402), the state of this node is updated into “communicating”. The transmission channel stored in the RTS message is set for “communicating”, and the transmission period (release time) of this channel is set (S403).

The channel status table updater 4 updates the channel status table 6 such that the node, which is adjacent to the transmitting node or the receiving node stored in the RTS message, is interfered with the transmission channel specified by the RTS message (S404) The node, which is adjacent to the transmitting node or the receiving node stored in the RTS message, can be determined as a node such that the adjacent node ID 23 includes the transmitting node or the receiving node by referring to the topology information table 7.

The method of updating the channel status table 6 is explained with reference to the topology status of FIG. 2 and the topology information table of FIG. 3 as examples.

The node “j” transmits the RTS message for posting the communication with the node “h” through the channel 1. The node “a” which receives the RTS message determines whether the transmitting/receiving nodes specified by the RTS message (nodes “j” and “h”) are adjacent nodes of the self node. With reference to the topology information table 7 (FIG. 3), since both the nodes “j” and “h” are not the adjacent nodes of the self node, the state 32 of the adjacent node is not updated. Then, the channel state 33 of the node adjacent to the transmitting/receiving nodes is updated. It is found that the node adjacent to the node “j” or “h” is the node “e” because the adjacent node ID 23 of the node “e” includes the node “j” or “h”. The channel status table updater 4, therefore, updates the channel status table 6 such that the node “e” is being interfered with the channel 1 (FIG. 4).

The node “m” transmits the RTS message for posting the communication with the node “g” through the channel 4. The node “a” which receives the RTS message determines whether the transmitting/receiving nodes specified by the RTS message (nodes “g” and “m”) are the adjacent nodes of the self node. Since these nodes are not the adjacent nodes, the state 32 of the adjacent node is not updated. The information that the adjacent nodes of the nodes “g” and “m” are the nodes “b” and “c” is acquired from the topology information table 7. The channel status table 6 is updated such that nodes “b” and “c” are interfered with the channel 4.

The node “i” transmits the RTS message for posting the communication with the node “k” through the channel 3. Since the node “k” is the node adjacent to the self node, the node “a” which receives the RTS message updates the state of the node “k” to “communicating”, and updates the channel status table 6 such that the node “k” is communicating through the channel 3. The channel status table 6 is also updated such that nodes “d” and “e” adjacent to the nodes “i” and “k” are interfered with the channel 3.

In the above explanation, the processes are categorized according to whether the transmitting/receiving nodes stored in the RTS message are the adjacent nodes of the self node. Specifically, when any one of the transmitting/receiving nodes is the adjacent node of the self node, the channel state of the adjacent node and the channel state of the self node are simultaneously updated. Also in this case, however, the channel status table 6 is seen to be updated such that the node adjacent to any one of the transmitting/receiving nodes stored in the RTS message cannot use a specified channel. In the case where the transmitting node is the two-hop distant node from the self node and the receiving node is the adjacent node of the self node, the channel status table is updated such that the receiving node and the self node cannot use specified channels. Here, the receiving node is the adjacent node of the transmitting node and the self node is the adjacent node of the receiving node. That is to say, steps S403 and S404 in the flowchart of FIG. 11 correspond to the process for updating the channel status table such that the node adjacent to any one of the transmitting node and the receiving node stored in the received RTS message cannot use the channel specified by the RTS message.

### Effects of the Invention

Each node in this embodiment posts the RTS message at a transmission distance twice as long as that of data packets or the like to surrounding nodes, so as to get information about the use condition (availability) of the channels as the format of the channel status table. When each node transmits data packets, each node refers to the channel status table 6 and easily acquires the channels available to both of the self node and the receiving node.

When the RTS message is posted directly to the node of two-hop distance, the packet which is transmitted through the control channel prior to the transmission of a data packet includes only RTS message. Therefore, even if the communication traffic increases, the possibility that the control channel is occupied by the control packet is reduced.

It is desirable that the all the nodes of two-hop distance can receive the RTS message at the transmission distance of the RTS message twice as long as that of the data packet or the like. However, the transmission distance of the RTS message may be shorter than the double distance of the data packet or the like. Even in this case, the possibility of packet collision can be reduced (though not as effective as described above).

Since the channel is switched between the control channel and the data channel in one of the two radio devices and the communication can be conducted by the above method, the other radio device can be specially allocated to the broadcast channel. The broadcast communication can be, therefore, always conducted.

In this embodiment, since the Hello message is exchanged and the topology of the two-hop distant nodes is obtained, singular adjacent node for the node of the two-hop distance, or the adjacent node that is a relay node for the most two-hop distant node can be selected as a relay node in flooding, so that efficient flooding can be executed.

### <Others>

The wireless communication method in this embodiment is more effective when it is applied to an ad-hoc wireless communication network. The ad-hoc wireless communication network is an autonomous wireless network which is temporarily constructed by mobile terminals. In the ad-hoc wireless communication network, when direct communication (1-hop communication) cannot be conducted between wireless communication devices which are separated from each other, a wireless communication device which is present therebetween relays the communication so that information is exchanged by multi-hop communication. In the multi-hop communication, since there is a possibility that channels are interfered in each hop, as the number of hops increases, the more notably the throughput is deteriorated. The wireless communication method which effectively avoids the channel interference is applied to the ad-hoc wireless communication network, thereby obtaining a great effect. An example of the ad-hoc wireless communication network includes a vehicle-to-vehicle ad-hoc wireless communication system which is composed of a wireless communication apparatus built into vehicles.

The transmission interval of the Hello message does not have to be a constant interval. The topology information table 7 does not have to be updated every time when the Hello message is received. For example, in the vehicle-to-vehicle ad-hoc wireless communication system, the transmission interval of the Hello message may depend on a speed of a self vehicle acquired from a vehicle speed sensor. The update timing of the topology information table 7 may depend on the vehicle speed. For example, it may depend how many times the Hello message has been received from one node to update the topology information table 7. When the speed of the self vehicle is slow, the network topology does not abruptly change. For this reason, the transmission interval of the Hello message may be lengthened or the topology information table 7 is updated after more Hello messages has been received, so that the processing load of the wireless communication apparatus can be reduced. Further, the transmission interval of the Hello message and the processing interval at the time of reception can be determined based on not the speed of the self vehicle but the speed of another vehicle or a relative speed or the like between the self vehicle and another vehicle.

This application claims priority from Japanese Patent Application No. 2006-85563 filed on Mar. 27, 2006, which is hereby incorporated by reference herein.

What is claimed is:

1. A wireless communication method in a wireless communication system using a plurality of channels, comprising:
the step of allowing each node in the wireless communication system to store channels available to a self node and a node adjacent to the self node in a channel status table; and
the step of allowing each node in the wireless communication system to select a channel to be used for transmission of a data packet based on the channel status table.

2. The wireless communication method according to claim 1, comprising:
the step of allowing a node transmitting a data packet to transmit a channel reservation notification to a primary adjacent node and a secondary adjacent node, the channel reservation notification notifying the channel to be used for the transmission, a transmitting node and a receiving node, the primary adjacent node being the node adjacent to the self node, and the secondary adjacent node being a node non-adjacent to the self node but adjacent to the primary adjacent node;
the step of allowing a node receiving the channel reservation notification to update the channel status table of the self node based on the received channel reservation notification; and
the step of allowing the node transmitting a data packet to select a channel available to the self node and the primary adjacent node as the channel to be used for the transmission of the data packet to the primary adjacent node, based on the channel status table.

3. The wireless communication method according to claim 2, further comprising:
the step of generating a topology information table in which the primary adjacent node and the secondary adjacent node are stored,
wherein the step of updating the channel status table includes:
the step of allowing the node receiving the channel reservation notification to acquire the primary adjacent node of the self node adjacent to any one of the transmitting node and the receiving node included in the received channel reservation notification based on the topology information table; and
the step of allowing the node receiving the channel reservation notification to update the channel status table such that the primary adjacent node cannot use a channel specified by the received channel reservation notification.

4. The wireless communication method according to claim 2, wherein
at the step of transmitting the channel reservation notification, a transmission distance of the channel reservation notification is made to be at least twice as long as a transmission distance of the data packet, so that the channel reservation notification is transmitted to both of the primary adjacent node and the secondary adjacent node.

5. The wireless communication method according to claim 4, wherein
at the step of transmitting the channel reservation notification, transmission radio field strength of the channel reservation notification is enhanced more than transmission radio field strength of the data packet, so that the transmission distance of the channel reservation notification is made to be at least twice as long as the transmission distance of the data packet.

6. The wireless communication method according to claim 4, wherein
at the step of transmitting the channel reservation notification, a modulating system of the channel reservation notification is made to be different from a modulating system of the data packet, so that the transmission distance of the channel reservation notification is made to be at least twice as long as the transmission distance of the data packet.

7. The wireless communication method according to claim 3, wherein the step of generating the topology information table comprises:
the step of allowing each node in the wireless communication system to transmit a topology information notification for notifying a set of the primary adjacent node and the secondary adjacent node of the self node; and
the step of allowing a node receiving the topology information notification to update the topology information table based on the received topology information notification.

8. The wireless communication method according to claim 7, wherein
the plural channels include a broadcast channel for transmitting a broadcast packet, a control channel for transmitting a control packet and a plurality of data channels for transmitting data packets,
the topology information notification is transmitted through the broadcast channel,
the channel reservation notification is transmitted through the control channel,
the data packet is transmitted through any of the plural data channels.

9. The wireless communication method according to claim 8, wherein
each node in the wireless communication system has first and second wireless communication devices,
the topology information notification is transmitted by the first wireless communication device,
the channel reservation notification is transmitted by the second wireless communication device,
the data packet is transmitted by the second wireless communication device.

10. A wireless communication apparatus that conducts wireless communication using a plurality of channels, comprising:
a channel status table in which a channel available to a self node and a primary adjacent node is stored, the primary adjacent node being a node adjacent to the self node; and
a channel selecting unit that selects a channel available to the self node and the primary adjacent node as a channel to be used for transmission of a data packet to the primary adjacent node based on the channel status table.

11. The wireless communication apparatus according to claim 10, further comprising:
a channel reservation notification transmission unit that transmits a channel reservation notification to the primary adjacent node and a second adjacent node, the channel reservation notification notifying the channel to be used for the transmission, a transmitting node and a receiving node, the secondary adjacent node being a node non-adjacent to the self node but adjacent to the primary adjacent node; and
a channel status table updating unit that updates the channel status table based on the received channel reservation notification.

12. A wireless communication program that allows wireless communication using a plurality of channels to be conducted, the program allowing a wireless communication apparatus having a channel status table which stores a channel available to a self node and a primary adjacent node therein to execute
the step of selecting a channel available to the self node and the primary adjacent node as a channel to be used for transmission of a data packet to the primary adjacent node based on the channel status table.

13. The wireless communication program according to claim 12, allowing the wireless communication apparatus to execute
the step of transmitting a channel reservation notification to the primary adjacent node and a second adjacent node, the channel reservation notification notifying the channel to be used for the transmission, a transmitting node and a receiving node, the second adjacent node being a node non-adjacent to the self node but adjacent to the primary adjacent node; and
the step of updating the channel status table based on the received channel reservation notification.
